(19) United States
(12) Patent Application Publication
(10) Pub. No.: US 2014/0345656 A1
(43) Pub. Date: Nov. 27, 2014

(54) ROLLER ASSEMBLY AND ROLL-TO-ROLL SYSTEM INCLUDING THE SAME

(71) Applicant: Samsung Display Co., Ltd., Yongin-city (KR)

(72) Inventor: Won-Hee OH, Yongin-city (KR)

(73) Assignee: Samsung Display Co., Ltd., Yongin-city (KR)

(21) Appl. No.: 14/197,568

(22) Filed: Mar. 5, 2014

(30) Foreign Application Priority Data
May 27, 2013 (KR) 10-2013-0059928

(51) Int. Cl. B05C 1/10

(52) U.S. Cl. CPC B05C 1/10
USPC 134/198

(57) ABSTRACT

Disclosed is a roller assembly, including a roller body portion and a first spray portion provided in the roller body portion to spray a first fluid onto a surface of a transfer member. The roller body portion and the first spray portion are configured to form an angle between the spraying direction of the first fluid and the surface of the transfer member.

### CROSS-REFERENCE TO RELATED APPLICATION

This application claims priority from and the benefit of Korean Patent Application No. 10-2013-0059928, filed on May 27, 2013, which is hereby incorporated by reference for all purposes as if fully set forth herein.

### BACKGROUND

1. Field

Exemplary embodiments of the present disclosure relate to a roller assembly and a roll-to-roll system including the same.

2. Discussion of the Background

Film-type materials may be used in various fields. Specifically, film-type materials may be used in various industrial fields, such as display panels, car seats, electronic paper, and the like. After being manufactured, film-type materials may be used for other electronic devices or other types of products. In this case, film-type materials may be supplied to apparatuses for manufacturing those electronic devices or products through roll-to-roll systems. In particular, when the film-type materials are widely used in manufacturing small scale electronic devices due to their slim size, removal of foreign substances attached on the surfaces of the film-type materials becomes a very important issue.

For example, when various film-type materials to be used in displays pass through roll-to-roll systems, if foreign substances created during the manufacturing process or from the roller assemblies and the environment are attached onto the surfaces of film-type materials, the products manufactured using the film-type materials may suffer malfunction or defects with them. Therefore, foreign substances attached on the surfaces of the film-type members should be removed before supplying the members for subsequent manufacturing apparatuses.

### SUMMARY

Exemplary embodiments of the present disclosure provide a roller assembly capable of removing foreign substances during the transfer of film-type materials, and a roll-to-roll system including the same.

According to one exemplary embodiment of the present disclosure, there is provided a roller assembly including a roller body portion and a first spray portion provided in the roller body portion to spray a first fluid onto a surface of a transfer member, wherein the roller body portion and the first spray portion are configured to form an angle between the spraying direction of the first fluid and the surface of the transfer member.

Further, according to one exemplary embodiment, there is provided a roll-to-roll system including: at least one roller assembly configured to spraying a fluid onto a surface of a transfer member at an angle and cause the transfer member to levitate; and a transfer roller assembly configured to be in contact with and transfer the flexible transfer member passing through the at least one roller assembly.

It is to be understood that both the foregoing general description and the following detailed description are exemplary and explanatory and are intended to provide further explanation of the invention as claimed.

### BRIEF DESCRIPTION OF THE DRAWINGS

The above and other features and advantages of the present invention will become more apparent by describing in detail exemplary embodiments thereof with reference to the attached drawings.

FIG. 1 is a schematic diagram of a roll-to-roll system according to one exemplary embodiment of the present disclosure.

FIG. 2 is a front view of the roll-to-roll system illustrated in FIG. 1.

FIG. 3 is a schematic diagram of a first roller assembly of FIG. 1 according to one exemplary embodiment of the present invention.

FIG. 4 is an enlarged view of portion A of FIG. 3.

### DETAILED DESCRIPTION OF THE ILLUSTRATED EMBODIMENTS

Hereinafter, exemplary embodiments of the present invention will now be described more fully with reference to the accompanying drawings. The accompanying drawings, which are included to provide a further understanding of the invention and are incorporated in and constitute a part of this specification, illustrate exemplary embodiments of the invention, and together with the description serve to explain the principles of the invention.

The present invention may, however, be embodied in various different forms, and should not be construed as being limited to the exemplary embodiments set forth herein. Rather, these embodiments are provided so that this disclosure will be thorough and complete, and will fully convey the scope of the present invention to those of ordinary skill in the art. The present invention is defined by the scope of the appended claims. The terms used in the present specification are merely used to describe particular embodiments, and are not intended to limit the present invention. An expression used in the singular encompasses the expression of the plural, unless it has a clearly different meaning in the context. In the present application, it is to be understood that the terms such as “comprises” and/or “comprising,” etc., are intended to indicate the existence of the elements, operations, actions and/or devices disclosed in the specification, and are not intended to preclude the possibility that one or more other elements, operations, actions and/or devices may exist or may be added. While terms such as “first,” “second,” etc., may be used to describe various components, such components should not be understood as being limited to the above terms. The above terms are used only to distinguish one component from another. Expressions such as “at least one of,” when preceding a list of elements, modify the entire list of elements and do not modify the individual elements of the list. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

In the drawings, the thickness of layers, films, panels, regions, etc. may be exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

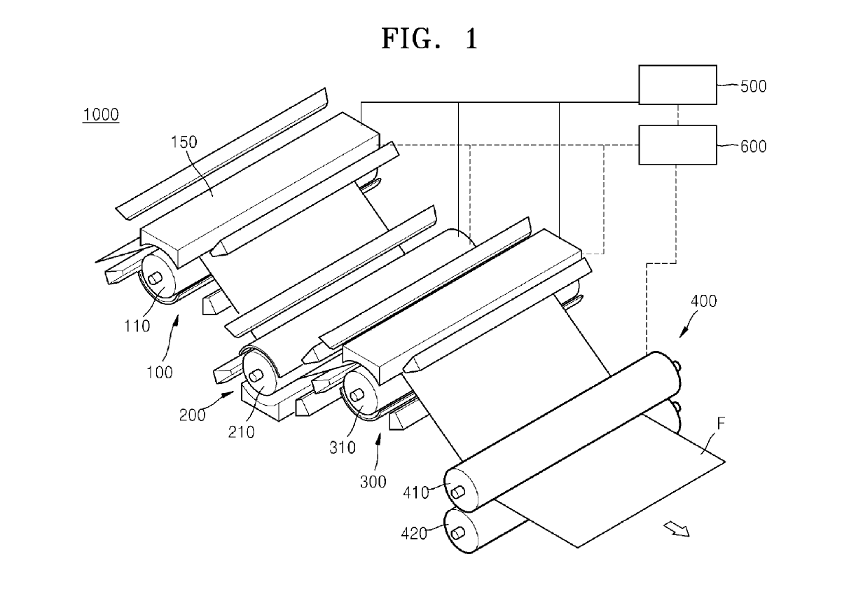

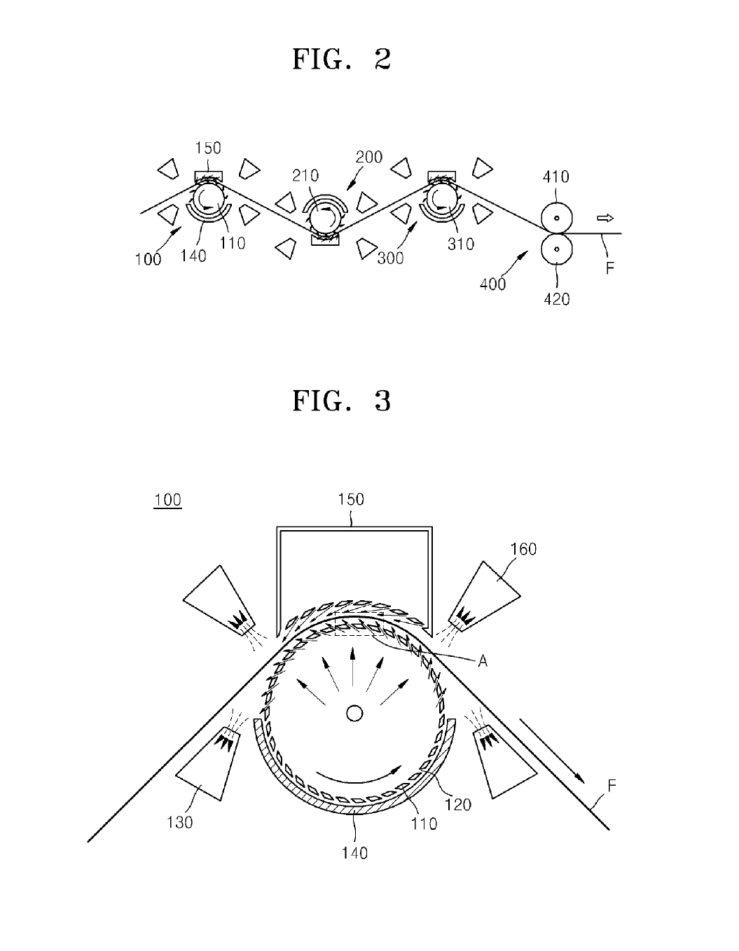

FIG. 1 is a schematic diagram of a roll-to-roll system 1000 according to one exemplary embodiment of the present disclosure. FIG. 2 is a front view of the roll-to-roll system 1000 illustrated in FIG. 1.

Referring to FIGS. 1 and 2, the roll-to-roll system 1000 may include at least one roller assembly (to which no reference numeral is assigned). According to one exemplary embodiment, the roller assembly may allow a transfer member F to levitate by spraying a fluid onto a surface of the transfer member F at a suitable angle, for instance, at an acute angle.

In accordance with one exemplary embodiment, a plurality of roller assemblies may be provided. In this case, the plurality of roller assemblies may include a first roller assembly 100, and a second roller assembly 200 spaced apart from the first roller assembly 100. In addition, the plurality of roller assemblies may further include a third roller assembly 300 spaced apart from the second roller assembly 200. The plurality of roller assemblies according to one exemplary embodiment are not limited to the above examples, and may include more than three roller assemblies. For ease of description, an example where the plurality of roller assemblies include the first to third roller assemblies 100 to 300 will be representatively described in more detail below.

In accordance with one exemplary embodiment, the first to third roller assemblies 100 to 300 may be formed to be similar to one another. In addition, the first to third roller assemblies 100 to 300 may be disposed at various positions.

For example, the first to third roller assemblies 100 to 300 may be disposed in a row along the transfer direction of the transfer member F. The first to third roller assemblies 100 to 300 may also be disposed in a zigzag form. The first to third roller assemblies 100 to 300 are not limited to the above examples. For ease of description, an example where the first to third roller assemblies 100 to 300 are disposed in a zigzag form will be representatively described in more detail below.

In accordance with one exemplary embodiment, the first to third roller assemblies 100 to 300 disposed in the above manner (i.e., in a zigzag form) may also be disposed to change the transfer directions of the transfer member F. For instance, the first roller assembly 100 may change a first inclined direction of the transfer member F being fed thereto to a second inclined direction, and the second roller assembly 200 may change the second inclined direction of the transfer member F being fed thereto to the first inclined direction. In addition, the third roller assembly 300 may change the first inclined direction of the transfer member F again to a third inclined direction.

The first to third roller assemblies 100 to 300 disposed in the above manner may be configured to remove foreign substances attached on the surface of the transfer member F. In this case, the first to third roller assemblies 100 to 300 may remove foreign substances from the surface of the transfer member F by spraying at least one of a first fluid and a second fluid onto the surface of the transfer member F. According to one exemplary embodiment, the first to third roller assemblies 100 to 300 may allow the transfer member F to levitate by spraying at least one of the first fluid and the second fluid at any suitable angle for removal of foreign particles or substances, for instance, at an acute or obtuse angle with respect to the surface of the transfer member F. For instance, the first to third roller assemblies 100 to 300 may spray at least one of the first fluid and the second fluid so as to form an acute angle between the spraying direction of the fluid and the transfer direction of the transfer member F.

In accordance with one exemplary embodiment, the first and second roller assemblies 100 and 200 may spray at least one of the first fluid and the second fluid in a direction opposite to each other with respect to the surface of the transfer member F. That is, the first roller assembly 100 may spray at least one of the first fluid and the second fluid onto the surface of the transfer member F in a direction opposite to the transfer direction of the transfer member F, and the second roller assembly 200 may spray at least one of the first fluid and the second fluid onto the surface of the transfer member F in the transfer direction of the transfer member F. In this case, the third roller assembly 300 may spray at least one of the first fluid and the second fluid onto the surface of the transfer member F in a similar manner to the first roller assembly 100.

In accordance with one exemplary embodiment, a first roller body portion 110 of the first roller assembly 100, a second roller body portion 210 of the second roller assembly 200, and a third roller body portion 310 of the third roller assembly 300 may be variously rotated. For instance, the first roller body portion 110 and the second roller body portion 210 may be rotated in different directions. That is, when the first roller body portion 110 is rotated clockwise, the second roller body portion 210 may be rotated counterclockwise. Alternatively, when the first roller body portion 110 is rotated counterclockwise, the second roller body portion 210 may be rotated clockwise. In this case, the third roller body portion 310 may be rotated, for instance, in the same direction as the first roller body portion 110.

However, the first to third roller body portions 110 to 310 are not limited to the arrangements and operations as described in the above examples, and the first to third roller body portions 110 to 310 may be operated to be equal to or different from one another as necessary. For ease of description, an example where the first roller body portion 110 and the third roller body portion 310 are rotated counterclockwise and the second roller body portion 210 is rotated clockwise will be representatively described in more detail below.

In accordance with one exemplary embodiment, the roll-to-roll system 1000 may include a transfer roller assembly 400 for conveying the transfer member F, while being in contact with it, as the transfer member F passes through the at least one roller assembly. Further, the transfer roller assembly 400 may include a first transfer roller 410, and a second transfer roller 420 installed to face the first transfer roller 410. For instance, the first and second transfer rollers 410, 420 may take up the transfer member F conveyed from the previous section, for instance, the third roller assembly 300, and keep the transfer member F moving ahead.

The first transfer roller 410 and the second transfer roller 420 may be disposed with a constant spacing therebetween, such that the transfer member F may be inserted into the spacing between the first transfer roller 410 and the second transfer roller 420. In this case, the transfer member F may be transferred by rotating at least one of the first transfer roller 410 and the second transfer roller 420 after the first transfer roller 410 and the second transfer roller 420 come into contact with each other.

In accordance with one exemplary embodiment, the first transfer roller 410 and the second transfer roller 420 may be rotated in an opposite direction, depending on the transfer direction of the transfer member F. For instance, the first transfer roller 410 may be rotated counterclockwise, while the second transfer roller 420 may be rotated clockwise. Alternatively, the first transfer roller 410 may be rotated clockwise, while the second transfer roller 420 may be rotated counterclockwise. For ease of description, an example where the transfer member F is transferred from left to right in FIG. 1, and the first transfer roller 410 and the second transfer roller 420 are rotated counterclockwise and clockwise respectively will be representatively described in detail below.

In accordance with one exemplary embodiment, the roll-to-roll system 1000 may include a fluid supply unit 500 that supplies the first fluid and the second fluid to the first to third roller assemblies 100 to 300. In this case, the fluid supply unit 500 may include a cylinder, a pump, and the like, and may include a fluid storage unit (not illustrated) that stores the fluids.

In addition to the above-described configuration, the roll-to-roll system 1000 may include a control unit 600 that controls the first to third roller assemblies 100 to 300, the transfer roller assembly 400, and the fluid supply unit 500. The control unit 600 may be any suitable type of device, including a personal computer (PC), an electronic terminal, and a mobile phone, which may input signals or control the overall operation of the roll-to-roll system 1000 based on stored data.

An exemplary operation of the roll-to-roll system 1000 is described below. The transfer member F may be supplied from the outside of the roller system. According to one exemplary embodiment, as described above, the transfer member F may be firstly bent by the first roller body portion 110 and be secondly bent by the second roller body portion 210. In addition, the transfer member F may be thirdly bent by the third roller body portion 310, so that the transfer member F may be inserted into the spacing between the first transfer roller 410 and the second transfer roller 420.

When the transfer member F is disposed in the above manner, the first transfer roller 410 and the second transfer roller 420 may be rotated to transfer the transfer member F. At this time, the control unit 600 may perform control such that at least one of the first transfer roller 410 and the second transfer roller 420 is rotated.

On the other hand, while the transfer member F is being transferred, the control unit 600 may supply the first fluid and the second fluid to the first to third roller assemblies 100 to 300 through the fluid supply unit 500. The first fluid may comprise the same materials as the second fluid or different materials.

The first to third roller assemblies 100 to 300, at which the first fluid and the second fluid are supplied, may be configured to cause the transfer member F to levitate by spraying at least one of the first fluid and the second fluid onto the lower surface of the transfer member F, for instance, from below. In this case, the control unit 600 may perform control such that the first to third roller assemblies 100 to 300 spray at least one of the first fluid and the second fluid onto the transfer member F at adequate liquid pressure.

In accordance with one exemplary embodiment, when at least one of the first fluid and the second fluid is sprayed upward onto the transfer member F, the transfer member F may be levitated as described above. For instance, the transfer member F may be slightly lifted by the spraying forces of the fluids and be spaced apart from the outer surface of at least one of the first to third roller body portions 110 to 310.

In accordance with one exemplary embodiment, while the above procedure is in progress, the control unit 600, as described above, may control at least one of the first transfer roller 410 and the second transfer roller 420 to take up the transfer member F and rotate so that the transfer member F moves along. By performing this process, foreign substances attached on the surface of the transfer member F may be removed through the first to third roller assemblies 100 to 300.

Therefore, the roll-to-roll system 1000 may effectively and quickly remove foreign substances from the surface of the transfer member F while moving the transfer member F along. In addition, because the transfer member F is substantially free from foreign substances after being subjected to the roll-to-roll system 1000, the end products using the transfer member F can advantageously have fewer defects that may be caused by foreign substances.

An exemplary configuration and operation of the first to third roller assemblies 100 to 300, which remove foreign substances from the surface of the transfer member F, will be described below in more detail. Since the first to third roller assemblies 100 to 300 are similar to one another, only the first roller assembly 100 will be representatively described below in detail for ease of description.

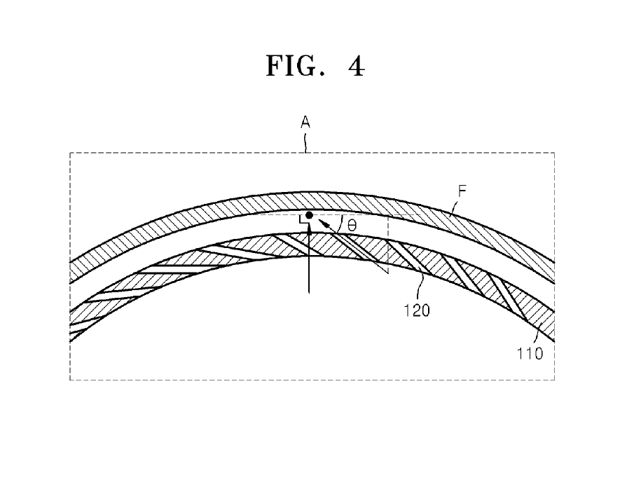

FIG. 3 is a schematic diagram of the first roller assembly 100 of FIG. 1 according to one exemplary embodiment of the present disclosure. FIG. 4 is an enlarged view of portion A of FIG. 3.

Referring to FIGS. 2 and 3, the first roller assembly 100, as described above, may spray at least one of the first fluid and the second fluid onto the surface of the transfer member F. For convenience, a case where the first roller assembly 100 sprays the first fluid onto a first surface of the transfer member F and sprays the second fluid onto a second surface of the transfer member F will be representatively described below in detail.

The first roller assembly 100 may include the first roller body portion 110. In accordance with one exemplary embodiment, the first roller body portion 110 may be formed in a cylindrical shape, and the length of the first roller body portion 110 may be substantially equal to or greater than the width of the transfer member F. In one exemplary embodiment, a space may be formed in the inside of the first roller body portion 110. The first fluid may be supplied from the fluid supply unit 500, which is connected to the first roller body portion 110, to the inside of the first roller body portion 110, and may then be supplied to a first spray portion 120 which is to be described below.

In addition, the first roller body portion 110 may be rotated during the transfer of the transfer member F. In this case, the rotating direction of the first roller body portion 110 may vary. For example, the rotating direction of the first roller body portion 110 may be clockwise or counterclockwise.

The first roller assembly 100 may include the first spray portion 120 formed in the first roller body portion 110. In this case, the first spray portion 120 may spray the first fluid onto the surface of the transfer member F. Specifically, the first spray portion 120 may spray the first fluid onto the surface of the transfer member F such that, for instance, an acute angle is formed between the spraying direction of the first fluid and the surface of the transfer member F. In particular, the first spray portion 120 may spray the first fluid onto the surface of the transfer member F such that an acute angle is formed between the spraying direction of the first fluid and the transfer direction of the transfer member F.

In addition, the first spray portion 120 may be provided on the surface of the first roller body portion 110. The first spray portion 120 may be provided in the form of holes to penetrate from the outer surface of the first roller body portion 110 to the inside of the first roller body portion 110. In particular, the hole-like first spray portion 120 may be inclined from the outer surface of the first roller body portion 110 to the inside of the first roller body portion 110. In other words, the first spray portion 120 may be formed at a predetermined angle with respect to the direction of the shortest distance between the outer surface of the first roller body portion 110 and the inside of the first roller body portion 110.

However, the structure of the first spray portion 120 is not limited to the above example. For instance, the first spray portion 120 may be a nozzle type spray portion that is installed in the first roller body portion 110 to spray the first fluid onto the surface of the transfer member F. For ease of description, an example where the first spray portion 120 is formed as holes will be representatively described below in detail.

A plurality of first spray portions 120 may be formed on the outer surface of the first roller body portion 110. In this case, the plurality of first spray portions 120 may be spaced apart from one another.

On the other hand, the first roller assembly 100 may include a first fluid blocking portion 140 spaced apart from the first roller body portion 110. The first fluid blocking portion 140 may be formed to have a curved surface similar to the outer surface shape of the first roller body portion 110. In particular, the first fluid blocking portion 140 may block part of the first fluid sprayed onto the outside of the first roller body portion 110 through the first spray portion 120 during the rotation of the first roller body portion 110.

In accordance with one exemplary embodiment, the first fluid blocking portion 140 may be formed to cover at least part of the first roller body portion 110. Further, the first fluid blocking portion 140 may be disposed to face at least part of the transfer member F. For instance, the first fluid blocking portion 140 may be disposed to face at least part of the transfer member F that is bent around the first roller body portion 110.

On the other hand, the first roller assembly 100 may include at least one first suction portion 130 spaced apart from the first roller body portion 110. In this case, the at least one first suction portion 130 may suction away the first fluid around the first roller body portion 110 during the rotation of the first roller body portion 110.

The at least one first suction portion 130 may be disposed in a suitable direction/position to suction away the first fluid around the first roller body portion 110. For instance, the first suction portion 130 may be disposed to suction the first fluid in the direction parallel to the transfer direction of the transfer member F. Further, the at least one first suction portion 130 may prevent the dropping of foreign substances by suctioning away those foreign substances released from the first surface of the transfer member F by the operation of the first spray portion 120.

In accordance with one exemplary embodiment, a plurality of first suction portions 130 may be provided and disposed at angles relative to each other. In particular, each of the plurality of first suction portions 130 may be disposed such that the inlet of each first suction portion 130 is parallel to the outer surface of the transfer member F.

Further, the first roller assembly 100 may include a second spray portion 150 disposed to face at least part of the first roller body portion 110. In this case, the second spray portion 150 may spray the second fluid onto the surface of the transfer member F. Further, the second spray portion 150 may form an acute angle between the spraying direction of the second fluid and the surface of the transfer member F.

The second spray portion 150 may spray the second fluid onto the second surface of the transfer member F. In addition, the first spray portion 120 may spray the first fluid onto the first surface of the transfer member F. The first surface and the second surface may be different surfaces of the transfer member F. For instance, the second surface may be opposite to the first surface of the transfer member F. Therefore, by respectively spraying the first fluid and the second fluid onto the first and second surfaces of the transfer member F, the first spray portion 120 and the second spray portion 150 may respectively remove foreign substances attached on the first and second surfaces of the transfer member F.

In accordance with one embodiment, the control unit 600 may adjust the liquid pressures of the first and second fluids so that the transfer member F may be in contact with or afloat over the first roller body portion 110. For instance, the pressure of the first fluid shot from the first spray portion 120 may be adjusted to be different from that of the second fluid shot from the second spray portion 150. In order to keep the transfer member F afloat over the first roller body portion 110 (i.e., not in contact therewith), the first spray portion 120 may be configured to shoot the first fluid at a higher pressure than that of the second fluid shot from the second spray portion 150. Also, the same effect can be achieved by configuring the sizes, numbers, and the like of the holes and/or nozzles on the first and second spray portions 120, 150 (e.g., by forming more holes on the first spray portion 120 than on the second spray portion 150). Further, the pressure of the first and second fluids may be maintained high enough to effectively remove undesirable foreign particles/substances from the surface of the transfer member F

In accordance with one embodiment, the first roller assembly 100 may include at least one second suction portion 160 disposed around the second spray portion 150. In this case, the at least one second suction portion 160 may suction away the second fluid around the first transfer member F during the rotation of the first roller body portion 110. In particular, the at least one second suction portion 160 may suction and remove foreign substances that are released from the second surface of the transfer member F and flow together with the second fluid.

In accordance with one exemplary embodiment, a plurality of second suction portions 160 may be provided, and the plurality of second suction portions 160 may be disposed at angles relative to each other. In addition, the plurality of second suction portions 160 may be disposed to be symmetrical to each other with respect to the second spray portion 150.

On the other hand, the first roller assembly 100 may allow the transfer member F to levitate during the operation of the roll-to-roll system 1000.

In accordance with one exemplary embodiment, as described above, the first fluid supplied from the fluid supply unit 500 to the inside of the first roller body portion 110 may be sprayed onto the first surface of the transfer member F. Further, an acute angle may be formed between the spraying direction of the first fluid and the first surface of the transfer member F, and the force applied by the first fluid to the first surface of the transfer member F in the direction perpendicular to the first surface of the transfer member F may be smaller than the force applied when the first fluid is vertically sprayed onto the first surface of the transfer member F. In addition, since the first fluid generates a force applied in the direction tangential to the first surface of the transfer member F, the force may be applied to foreign substances attached on the first surface of the transfer member F, resulting in the removal of the foreign substances.

On the other hand, during the above-described operation, the first suction portion 130 may suction away the first fluid and the foreign substances released by the first fluid as described above.

Moreover, the first fluid blocking portion 140 may be disposed under the first roller body portion 110 to block the first fluid sprayed from the first spray portion 120 to the portion facing the bent portion of the transfer member F, preventing the released foreign substances from being scattered.

On the other hand, during the above-described operation, the second fluid sprayed from the second spray portion 150 may remove foreign substances from the second surface of the transfer member F in a similar manner to the first fluid sprayed from the first spray portion 120.

The second fluid may remove foreign substances attached on the second surface of the transfer member F by applying a force to the foreign substances, which are attached on the second surface of the transfer member F, in a tangential direction to the second surface of the transfer member F.

Therefore, the first roller assembly 100 may effectively remove the foreign substances attached on the surface of the transfer member F by spraying at least one of the first fluid and the second fluid onto the surface of the transfer member F.

According to the above exemplary embodiments of the present invention, foreign substances may be effectively and quickly removed from the surface of the transfer member by spraying the fluid onto the surface of the transfer member. Furthermore, according to the above exemplary embodiments of the present invention, at the time of manufacturing the end products including the transfer member, the defect rate of the end products due to foreign substances that may be attached on the surface of the transfer member may be significantly reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A roller assembly, comprising:
a roller body portion; and
a first spray portion provided in the roller body portion and configured to spray a first fluid onto a surface of a transfer member,
wherein the roller body portion and the first spray portion are disposed to form an acute angle between a spraying direction of the first fluid and the surface of the transfer member.

2. The roller assembly of claim 1, wherein the roller body portion comprises a space formed therein, and the first fluid is supplied to the first spray portion through the space.

3. The roller assembly of claim 1, wherein the roller body portion is configured to rotate while the transfer member is being transferred, and
wherein the transfer member comprises a flexible material.

4. The roller assembly of claim 1, wherein the first spray portion is configured to spray the first fluid onto the surface of the transfer member to cause the transfer member to levitate from the roller body portion.

5. The roller assembly of claim 1, further comprising a fluid blocking portion spaced apart from the roller body portion to block part of the first fluid sprayed from the first spray portion to an outside of the roller body portion.

6. The roller assembly of claim 5, wherein the fluid blocking portion covers part of the roller body portion.

7. The roller assembly of claim 5, wherein the fluid blocking portion is disposed to face at least part of the transfer member.

8. The roller assembly of claim 1, further comprising at least one first suction portion spaced apart from the roller body portion to suction away the first fluid around the roller body portion during rotation of the roller body portion.

9. The roller assembly of claim 8, wherein the at least one first suction portion is disposed to suction away the first fluid around the roller body portion in a direction parallel to a transfer direction of the transfer member.

10. The roller assembly of claim 1, further comprising a second spray portion disposed to face at least part of the roller body portion to spray a second fluid onto another surface of the transfer member.

11. The roller assembly of claim 10, wherein an acute angle is formed between an spraying direction of the second fluid and the another surface of the flexible transfer member.

12. The roller assembly of claim 10, further comprising at least one second suction portion spaced apart from the second spray portion.

13. The roller assembly of claim 12, wherein the at least one second suction portion suctions away the second fluid around the transfer member during the rotation of the roller body portion.

14. A roll-to-roll system, comprising:
at least one roller assembly configured to spray a fluid onto a surface of a transfer member at an acute angle and cause the transfer member to levitate; and
a transfer roller assembly configured to be in contact with and transfer the flexible transfer member passing through the at least one roller assembly.

15. The roll-to-roll system of claim 14, wherein the at least one roller assembly comprises:
a roller body portion; and
a first spray portion provided in the roller body portion to spray a first fluid constituting the fluid onto the surface of the transfer member,
wherein the transfer member comprises a flexible material.

16. The roll-to-roll system of claim 15, wherein the at least one roller assembly further comprises a fluid blocking portion spaced apart from the roller body portion to block part of the first fluid sprayed from the first spray portion.

17. The roll-to-roll system of claim 15, wherein the at least one roller assembly further comprises at least one first suction portion spaced apart from the roller body portion to suction away the first fluid around the roller body portion during rotation of the roller body portion.

18. The roll-to-roll system of claim 14, wherein the at least one roller assembly comprises a second spray portion configured to spray a second fluid onto another surface of the flexible transfer member.

19. The roll-to-roll system of claim 18, wherein the at least one roller assembly further comprises at least one second suction portion spaced apart from the second spray portion to suction away the second fluid around the flexible transfer member.
